(19) United States
(12) Patent Application Publication
(10) Pub. No.: US 2006/0091841 A1
(43) Pub. Date: May 4, 2006

(54) Relay for a direct current electrical apparatus

(76) Inventor: Anthony Roussel, Saint Denis En Val (FR)

Correspondence Address: CARLSON, GASKEY & OLDS, P.C., 400 WEST MAPLE ROAD, SUITE 350, BIRMINGHAM, MI, 48009, US

(21) Appl. No.: 11/254,239

(22) Filed: Oct. 19, 2005

(30) Foreign Application Priority Data
Nov. 2, 2004 (FR) 04 11 641

(51) Int. Cl. H02P 1/00

(52) U.S. Cl. 318/445

(57) ABSTRACT

An electric control device for the switching of an apparatus operating on direct current at a predetermined supply voltage includes an electromechanical relay having a changeover switch of the apparatus and at least two brush holders that form changeover switch contacts.

### REFERENCE TO RELATED APPLICATION

This application claims priority to French Patent Application FR 04 11 641 filed on Nov. 2, 2004.

### BACKGROUND OF THE INVENTION

This invention relates to an electrical relay connected with an apparatus designed to operate on direct current DC, for example at 12V or more.

Today, motor vehicle batteries deliver 12V of direct current, and electrical apparatuses arranged in motor vehicles therefore conventionally operate at 12V DC. These apparatuses, such as for example a window regulator motor, are generally controlled by a relay designed to switch a switch of the apparatus.

A relay is an electromagnetic control device operated to switch an electrical circuit on or off. Conventionally, a relay includes a coil coupled with a magnet linked to a switch. When a control voltage is applied to the coil, the magnetic field produced causes the switching of the switch. Moreover, the relay also allows for the absorption of the electric arc produced by the excess voltage at terminals of the apparatus when the electrical power supply is interrupted. The electric arc corresponds to a discharge between the terminals of the switch when separated from each other while a current flows through them. The supply current to the apparatus does not immediately become zero when the switch is open because of the capacitive or inductive load of the apparatus. This discharge can be drained off between the contacts of the relay. More specifically, the relay generally controls the power supply to brushes designed to come into contact with an electric motor commutator.

FIG. 1 illustrates a direct current electric motor, such as a window regulator motor, for example. An electric motor 10 generally includes a stator casing and a rotor 20 mounted rotatably in the stator casing. The motor 10 also includes a commutator 15 which is conventionally made of a ring securely mounted on the rotor 20 and having a series of conductive segments on its periphery.

The segments of the commutator 15 are connected to windings of the rotor 20. At least two diametrically opposed segments are successively supplied with electric current by at least one pair of brushes 11 and 12. The brushes 11 and 12 are generally arranged on a brush holders 13 that can be arranged on a commutator housing or directly on a printed circuit board 100, integrating motor control electronics. The brushes 11 and 12 are arranged in a diametrically opposed fashion relative to the commutator 15 and are designed to make contact with the segments of the commutator 15 during its rotation linked to the rotor 20 to successively power the windings of the rotor 20. To this end, a relay 1 controls the power supply to the brushes 11 and 12 via the brush holders 13.

FIG. 2 schematically illustrates an electrical circuit of the motor 10 in FIG. 1.

An apparatus, such as a motor 10 for actuating a vehicle vent such as a window regulator motor, should be supplied with direct current at a predetermined supply voltage Ua that generally corresponds to the voltage delivered by the battery of the vehicle, such as for example 12 volts.

In FIG. 2, the motor 10 is shut down, and the terminals 21 and 22 of the motor 10 (corresponding to the supply brushes 11 and 12 of the commutator 15 in FIG. 1) are connected to the same point of potential. The motor 10 is therefore short-circuited. The terminals 21 and 22 of the motor 10 are connected to switches 3 and 4 controlled by the relay 1. The control of the switching of the relay 1 can be carried out by a dedicated electrical circuit, such as a microcontroller 5, for example.

To start the motor 10, i.e., to connect one terminal 21 of the motor 10 to a supply potential Ua and the other terminal 22 to the ground, one of the switches 4 must be switched. The direction of rotation of the motor 10 will be determined according to whichever terminal 21 or 22 of the motor 10 is connected to the supply Ua by switching one of the corresponding switches 3 or 4. The other terminal 21 or 22 of the motor 10 is connected to the ground.

The relay 1 and the microcontroller 5, as well as the supply terminals of the brushes 11 and 12, can be integrated into a printed circuit board 100 connected to the motor 10, as illustrated in FIGS. 1 and 3.

FIG. 3 shows the printed circuit board 100 including the relay 1. In a manner known per se, the relay 1 can include two coils 6 and 7 each coupled with a magnet linked to one of the switches 3 and 4. A control of the microcontroller 5 allows for a current to be applied to one of the coils 6 and 7 to produce a magnetic field designed to actuate one of the switches 3 and 4 by one of the magnets.

FIG. 3 also shows the brush holders 13 connected to the brushes 11 and 12 for power supply to the motor 10 and to electrical connection pins 14 arranged on the printed circuit board 100. Each connection pin 14 of the brush holders 13 is electrically connected to a control switch 3 and 4 of the relay 1 via a conduction track 16 of the printed circuit board 100 and a connection pin 17 in the relay 1.

Despite being integrated into the same printed circuit board 100, the relay 1 and the brush holders 13 remain distinct components which require electrical connections to be provided between them.

For certain applications, direct current electric motors are increasingly small. Maximum integration is therefore desirable to obtain a minimum volume occupied and to make the assembly of the different components as easy as possible.

A need therefore exists for maximum integration of the electrical components into a printed circuit board linked to a direct current electric motor. In particular, a need exists for the elimination of certain electrical connections between these different components and for minimizing the number of connection pins.

### SUMMARY OF THE INVENTION

The invention provides an electric control device for switching an apparatus operating on direct current at a predetermined supply voltage. The device includes an electromechanical relay having a changeover switch of the apparatus and at least two brush holders forming changeover switch contacts.

According to one embodiment, the changeover switch includes two switches each having a contact formed by a brush holder. According to one embodiment, the switches are inductive switches. According to one embodiment, the changeover switch includes two pins for contact with each power supply pin of the apparatus. According to another embodiment, the changeover switch includes a single pin for contact with at least one of the power supply pins of the apparatus.

According to one embodiment, the device also includes a microcontroller designed to control a state of the changeover switch of the relay. According to one embodiment, the microcontroller controls at least one coil designed to actuate a switch. According to one embodiment, there are two coils having a common contact pin. According to one embodiment, one coil has a common contact pin with a power supply pin of the apparatus.

The invention also relates to a vehicle vent actuation motor including a commutator and a printed circuit board integrating a control device according to the invention. The brush holders include brushes designed to make contact with the commutator.

### BRIEF DESCRIPTION OF THE DRAWINGS

Other characteristics and advantages of the invention will become apparent when reading the following detailed description of the embodiments of the invention, given as an example only and with reference to the drawings, which show:

FIG. 1, already described, is a diagram of a direct current electric motor according to the prior art;

FIG. 2, already described, is a diagram of an electrical circuit of the motor in FIG. 1;

FIG. 3, already described, is a diagram of a printed circuit board of the motor in FIG. 1;

FIG. 4 is a diagram of a printed circuit board according to a first embodiment of the invention;

FIG. 5 is a diagram of the printed circuit board according to a second embodiment of the invention;

FIG. 6 is a diagram of the printed circuit board according to a third embodiment of the invention;

FIG. 7 is a diagram of the printed circuit board according to a fourth embodiment of the invention; and

FIG. 8 is a diagram of the printed circuit board according to a fifth embodiment of the invention.

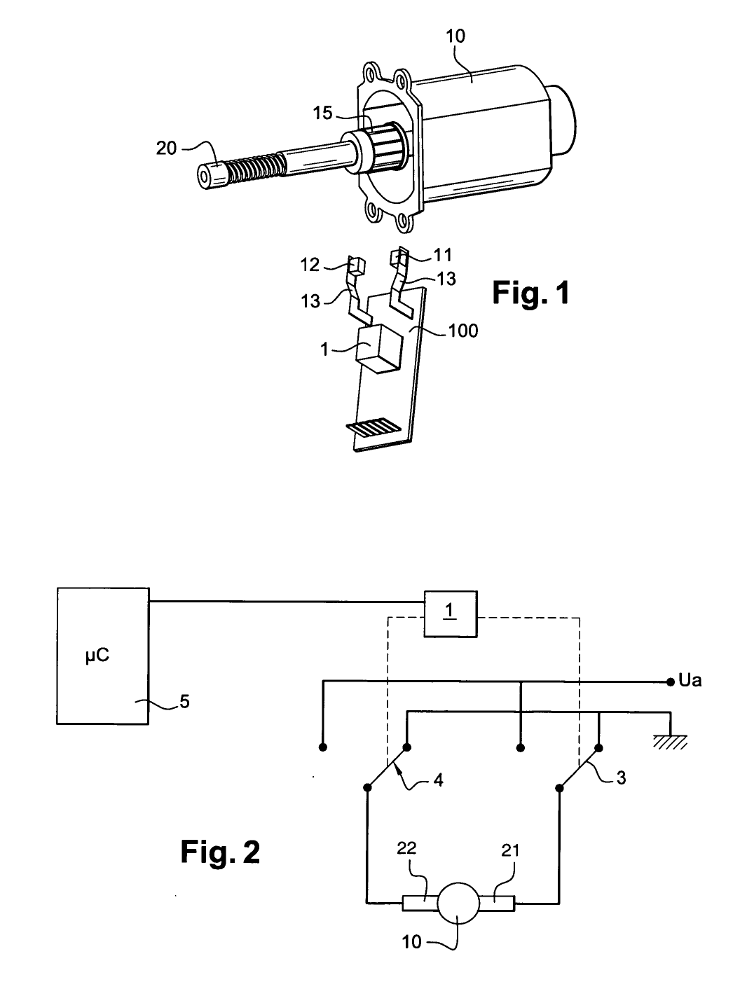

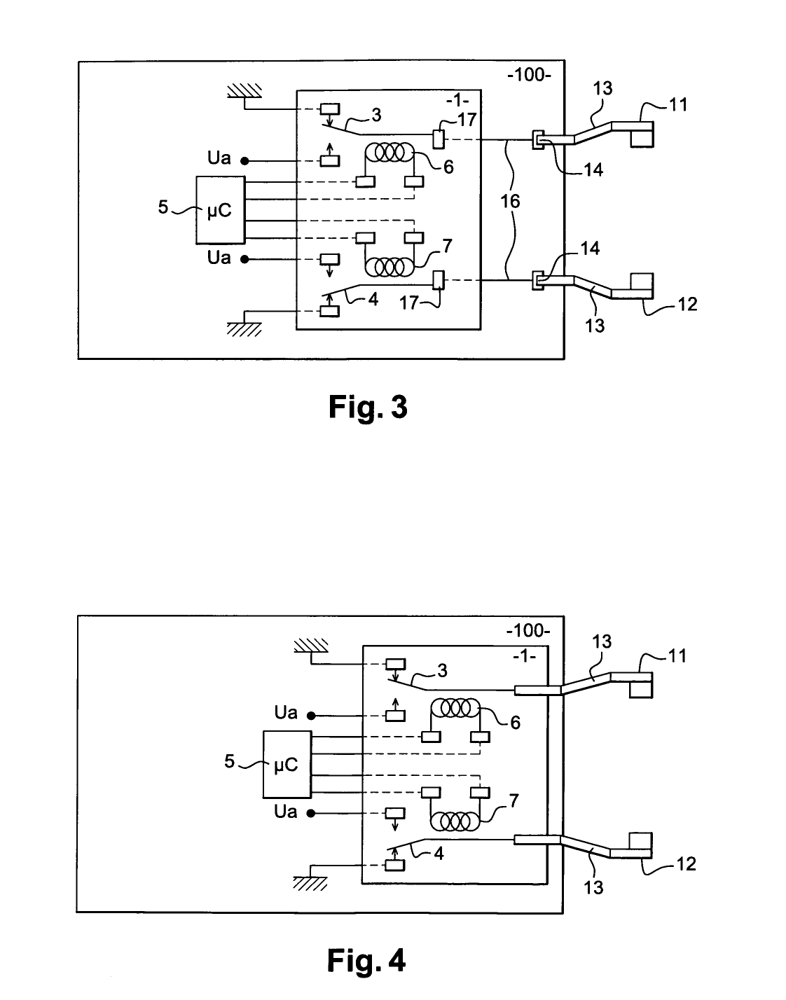

### DETAILED DESCRIPTION OF THE PREFERRED EMBODIMENT

An electric control device for switching an apparatus operating on direct current at a predetermined supply voltage includes an electromechanical relay. According to the invention, the relay includes a changeover switch of the apparatus and at least two brush holders forming changeover switch contacts.

Thus, the electrical tracks between the relay and the brush holders are eliminated, as well as the pins for connecting the relay to these tracks, because the brush holder itself forms a changeover switch contact.

The invention will be described with reference to FIGS. 4 to 8, which show five embodiments of the invention. According to the invention, an open state and a closed state of a switch of the relay are defined as states corresponding, respectively, to the passage of a supply current through the apparatus and to the interruption of the passage of the current through the apparatus. The interruption of the passage of the supply current in the apparatus can be obtained either by short-circuiting the apparatus or by opening the circuit.

FIG. 4 shows a printed circuit board 100 including a relay 1. The relay 1 can include two coils 6 and 7 each coupled with a magnet linked to a switch 3 and 4. FIG. 4 also shows brush holders 13 connected to brushes 11 and 12 for supplying power to the motor. According to the invention, the brush holders 13 also form contacts of the switches 3 and 4 of the relay 1. Thus, the electrical connection pins 14 arranged on the printed circuit board 100, the connection pins 17 in the relay 1 and the connection tracks 16 of the printed circuit board 100 can be eliminated.

In FIG. 4, the motor is shut down because the brushes 11 and 12 are electrically connected to the same point of potential. The motor is therefore short-circuited, and the switches 3 and 4 are each in a so-called open state according to the definition given previously.

To start the motor, one brush 11 must be connected to the supply potential Ua, and the other brush 12 is connected to the ground. One of the switches 4 must therefore be switched to a closed state on a supply terminal.

The switching of the switches 3 and 4 can be carried out by a microcontroller 5. The microcontroller 5 applies a control voltage intended to supply one of the coils 6 and 7 of the relay 1 to actuate the switching of one of the switches 3 and 4. The microcontroller 5 can also measure the value of the supply voltage Ua to actuate software circuit breakers, for example in the event of the detection of torque greater than a predetermined threshold on the rotor of the motor. Moreover, the microcontroller 5 monitors the operating state of the motor 10. In particular, the closed state or the open state of the switches 3 and 4 controlled by the relay 1 by the microcontroller 5 is known.

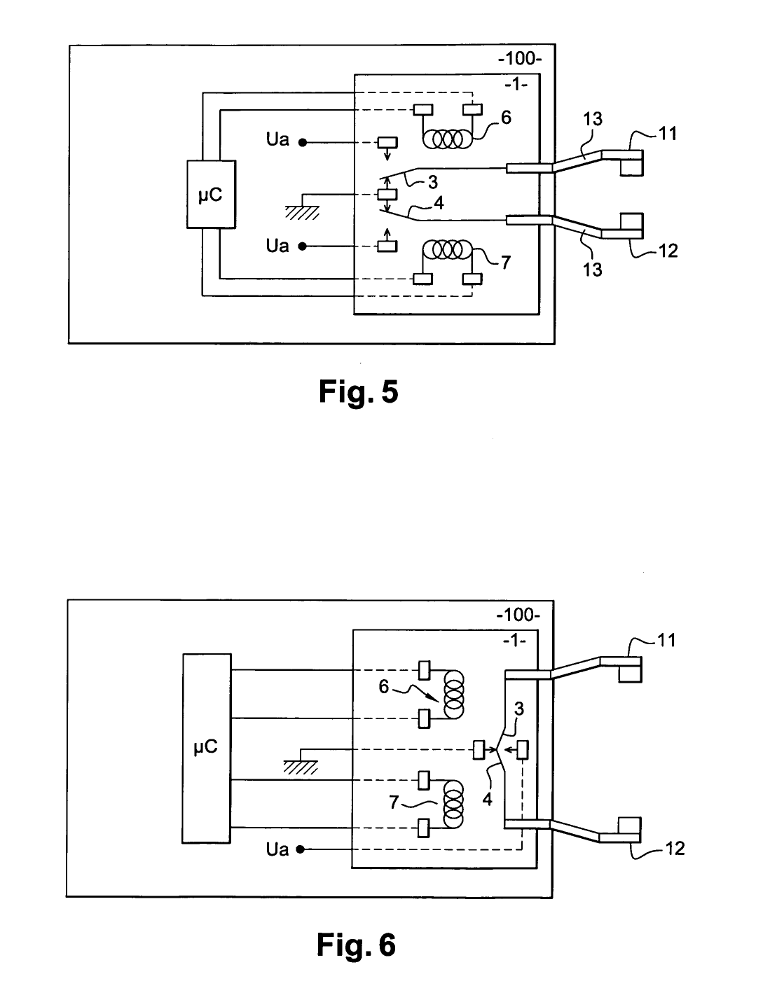

FIGS. 5 to 8 show variants of embodiment of the control device in FIG. 4. The same components have the same numbers. In FIG. 5, the brush holders 13 still form the contacts of the switches 3 and 4 of the relay 1. Moreover, it has been possible to eliminate an additional pin by using a single pin as the ground contact for the two switches 3 and 4.

In FIG. 6, the brush holders 13 still form the contacts of the switches 3 and 4 of the relay 1. Moreover, it is possible to eliminate an additional pin by using a single pin as a supply contact Ua for the two switches 3 and 4.

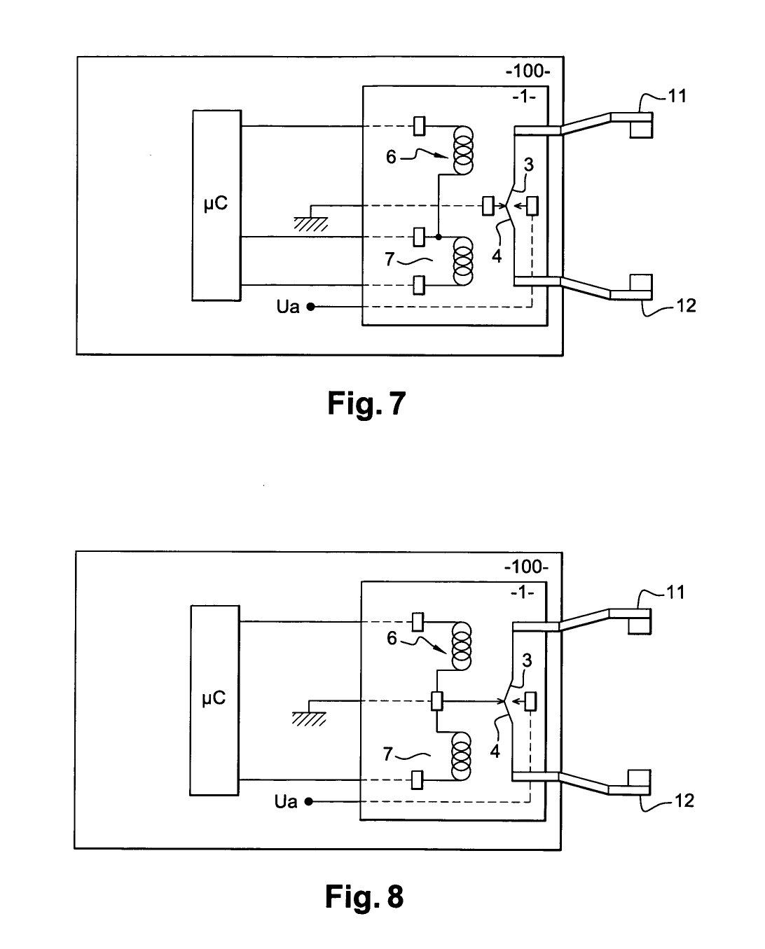

In FIG. 7, the brush holders 13 still form the contacts of the switches 3 and 4 of the relay 1. Moreover, it is possible to eliminate an additional pin by using a single pin as a supply contact for the control of one of the pins of the two coils 6 and 7.

In FIG. 8, the brush holders 13 still form the contacts of the switches 3 and 4 of the relay 1. Moreover, it is possible to eliminate an additional pin by using a single pin as a supply contact for the control of one of the pins of the two coils 6 and 7, as in FIG. 7, with the single pin additionally forming the ground contact pin of the switches 3 and 4.

In all the examples illustrated, the ground and supply contact pins can be inverted at will, in particular for FIG. 8 where the single supply contact pin for the control of one of the pins of the two coils 6 and 7 can also form the supply contact pin of the switches 3 and 4. Moreover, the various simplifications illustrated by eliminating pins can be combined at will.

According to the invention, an electrical component is therefore obtained formed by a relay 1 equipped with brush holders 13. Such a component allows for better integration of the electrical components for less space occupied in an electric motor. Moreover, the assembly of the motor is facilitated by this integration.

Of course, this invention is not limited to the embodiments described as an example. Thus, the relay 1 of the switching device according to the invention can include only one switch, the two contacts of which are formed by the two brush holders 13. Similarly, the supply voltage Ua can be different than 12 V.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. An electric control device for the switching of an apparatus operating on direct current at a predetermined supply voltage, the electric control device comprising:
an electromechanical relay including a changeover switch of the apparatus and at least two brush holders forming changeover switch contacts.

2. The electric control device according to claim 1, wherein the changeover switch comprises two switches that each include a contact formed by one of the at least two brush holders.

3. The electric control device according to claim 2, wherein the two switches are inductive switches.

4. The electric control device according to claim 1, wherein the apparatus includes power supply pins, and the changeover switch comprises two pins that each contact with one of the power supply pins.

5. The electric control device according to claim 1, wherein the apparatus includes power supply pins, and the changeover switch comprises a single pin for contact with at least one of the power supply pins.

6. The electric control device according to claim 1, further comprising a microcontroller to control a state of the changeover switch of the electromechanical relay.

7. The electric control device according to claim 6, further including at least one coil to actuate a switch, wherein the microcontroller controls the at least one coil.

8. The electric control device according to claim 7, wherein the at least one coil comprises two coils that have a common contact pin.

9. The electric control device according to claim 7, wherein the apparatus includes a power supply pin, and the at least one coil and the power supply pin have a common contact pin.

10. A vehicle vent activation motor comprising:
a commutator;
a printed circuit board integrating a control device for switching of an apparatus operating on direct current at a predetermined supply voltage; and
the control device including an electromechanical relay having a changeover switch of the apparatus and at least two brush holders forming changeover switch contacts, wherein the at least two brush holders include brushes to contact the commutator.
